(19) United States
(12) Patent Application Publication
(10) Pub. No.: US 2016/0066121 A1
(43) Pub. Date: Mar. 3, 2016

(54) METHODS AND SYSTEMS FOR MANAGING CHARGING INFORMATION IN A MACHINE-TO-MACHINE (M2M) NETWORK

(71) Applicant: George Foti, Dollard des Ormeaux (CA)

(72) Inventor: George Foti, Dollard des Ormeaux (CA)

(73) Assignee: TELEFONAKTIEBOLAGET L M ERICSSON (PUBL), Stockholm (SE)

(21) Appl. No.: 14/385,944

(22) PCT Filed: Aug. 27, 2014
(86) PCT No.: PCT/IB2014/064100

§ 371 Date: Sep. 17, 2014

(51) Int. Cl. H04W 4/00

(52) U.S. Cl. CPC H04W 4/005; H04W 4/24

(57) ABSTRACT

Methods and related systems for managing charging information in a machine-to-machine (M2M) network are disclosed. The methods generally allow the central node in a M2M network responsible for managing charging events to receive the necessary information without having to process every request. The methods generally allow communication nodes in the M2M network to process and route requests to access resources without having the central node having to process the requests. Still, the methods involve the transmission, by the communication nodes, of charging-related information or notifications to the central node to allow the central node to properly monitor and manage the charging information.

### TECHNICAL FIELD

The present disclosure generally relates to communication networks and systems and more particularly to machine-to-machine (M2M) communication networks and systems.

### BACKGROUND

With recent advances in communication networking technologies, machines and other devices are increasingly provided with networking capabilities, making these machines and devices capable of transmitting and receiving data over communication networks without human interventions.

Systems in which machines are able to communicate between themselves over communication networks are generally referred to as machine-to-machine (M2M) systems or machine-type-communication (MTC) systems.

Examples of M2M machines include smart meters (e.g. electric meters, water meters, etc.) provided with communication interfaces that allow them to transmit usage data directly to the utility, via a communication network, without the need for a person to actually perform any reading of the meters. Understandably, the market for M2M systems is vast as many applications and systems could take advantages of the many benefits of M2M communications.

In current M2M system architectures, all the nodes of a M2M system are under the supervision of a single central node, sometimes referred to as a M2M infrastructure node, in cooperation with other nodes in the field such as gateways, etc. This infrastructure node generally provides the interface between the field domain in which the M2M network nodes are located and the infrastructure domain in which the M2M service provider nodes are located.

In such architectures, when an application associated with one network node desires to have access to a resource, the request must be processed by the infrastructure node in order for the infrastructure node to properly monitor any events occurring between network nodes and their associated applications and/or resources that could involve charging. However, such centralized processing puts an additional burden on the infrastructure node since it has to process each and every request. Such centralized processing can also cause the infrastructure node to become a bottleneck, reducing the overall performances of the M2M network as the number of network nodes, and the number of requests, increase.

Therefore, it would be desirable to provide methods and systems that obviate or mitigate the above described problems.

### SUMMARY

It is an object of the present invention to obviate or mitigate at least one disadvantage of the prior art.

In accordance with one broad aspect of the present invention, there is provided methods and related systems for managing charging information in a machine-to-machine (M2M) network. The method generally allows the node in a M2M network responsible for managing charging events (hereafter the “infrastructure node” or the “M2M infrastructure node”) to receive the necessary information without having to process every request.

According to an exemplary embodiment, the method for managing charging information in a M2M network generally comprises: at a network node, receiving, from an application, a request to access a resource; accessing the requested resource if the requested resource is hosted on the network node, or forwarding the request to a second network node if the requested resource is determined to be hosted on the second network node, the accessing or the forwarding being performed in accordance with determining in which network node the requested resource is hosted; receiving a response comprising an indication of the access to the resource; responsive to receiving the response, generating a notification comprising at least some information from the request or from the response; and transmitting the notification to the infrastructure node.

In such embodiment, when the infrastructure node receives the notification, the infrastructure node will simply extract the necessary information (e.g. application ID, resource ID, request type, etc.) from the notification in order to be able to generate the appropriate charging data record (CDR) for the request. The CDR can then be processed locally or forwarded to and processed by a charging node.

In some embodiments, the notification is transmitted to a predetermined address of the infrastructure node.

In some embodiments, the method may further comprise forwarding the response to the application. This could occur if, for instance, the application requires receiving the response (e.g. the response contains the data requested by the application).

In some embodiments, the requesting application is associated with the network node.

In some embodiments, the notification transmitted to the infrastructure node is substantially a copy of the request or of the response received by the network node. In some other embodiments, the notification is a modified version of the request or of the response. In still some other embodiments, the notification is a new message comprising at least some information from the initial request and from the response.

In some embodiments, the method may further comprise receiving a second response from the infrastructure node. The second response generally comprises an indication (e.g. confirmation) of the reception of the notification by the infrastructure node. The reception of this second response by the network node allows the network node to handle transmission errors (e.g. through retransmission of the notification if no second response is received).

According to another exemplary embodiment, there is provided a M2M network node comprising: a communication interface; a memory for storing instructions; and a processor. The processor is operatively connected to the communication interface and to the memory. Upon executing the instructions stored in the memory, the processor is adapted to: determine that a request for access to a resource is received at the communication interface, the request being received from an application; determine in which M2M network node the requested resource is hosted; access the requested resource, if the requested resource is determined to be hosted on the M2M network node, or cause the communication interface to forward the request to another M2M network node, if the requested resource is determined to be hosted on the another M2M network node; determine that a response comprising an indication of the access to the resource is received; generate a notification comprising at least some information from the request or from the response; and cause the communication interface to transmit the notification to the infrastructure node.

When the infrastructure node receives the notification, the infrastructure node will simply extract the necessary information (e.g. application ID, resource ID, request type, etc.) from the notification in order to be able to generate the appropriate charging data record (CDR) for the request. The CDR can then be processed locally or forwarded to and processed by a charging node.

In some embodiments, the processor may be further adapted to cause the communication interface to transmit the notification to a predetermined address on the infrastructure node.

In some embodiments, the requesting application is associated with the M2M network node.

In some embodiments, the notification generated by the processor is substantially a copy of the request or of the response received by the M2M network node. In some other embodiments, the notification generated by the processor is a modified version of the request or of the response. In still some other embodiments, the notification generated by the processor is a new message comprising at least some information from the request and from the response.

In some embodiments, the processor may be further adapted to cause the communication interface to forward the response to the application.

In some embodiments, the processor may be further adapted to determine that a second response, generally comprising an indication (e.g. confirmation) of the reception of the notification by the infrastructure node, is received at the communication interface.

According to another exemplary embodiment, the method for managing charging information in a M2M network generally comprises: at a network node, receiving, from an application, a request to access a resource; accessing the requested resource, if the requested resource is determined to be hosted on the network node, or forwarding the request to a second network node, if the requested resource it is determined to be hosted on the second network node, the accessing or the forwarding being performed in accordance with determining in which network node the requested resource is hosted; receiving a response comprising an indication of the access to the resource; responsive to receiving the response, generating a charging record comprising an indication of the access to the resource by the application; and transmitting the charging record to the infrastructure node.

In some embodiments, the application is associated with the network node.

In some embodiments, the method may further comprise forwarding the response to the application.

In some embodiments, the method may further comprise receiving a second response from the infrastructure node. The second response generally comprises an indication of the reception of the charging record by the infrastructure node. The reception of this second response by the network node allows the network node to handle transmission errors (e.g. through retransmission of the charging record if no second response is received).

According to another embodiment, there is provided a M2M network node comprising: a communication interface; a memory for storing instructions; and a processor. The processor is operatively connected to the communication interface and to the memory. Upon executing the instructions stored in the memory, the processor is adapted to: determine that a request for access to a resource is received at the communication interface, the request being received from an application; determine in which M2M network node the requested resource is hosted; access the requested resource, if the requested resource is determined to be hosted on the M2M network node, or cause the communication interface to forward the request to another M2M network node, if the requested resource is determined to be hosted on the another M2M network node; determine that a response comprising an indication of the access to the resource is received; generate a charging record comprising an indication of the access of the resource by the application; and cause the communication interface to transmit the charging record to the infrastructure node.

When the infrastructure node receives the CDR, it can process the CDR locally or forward it to a charging node.

In some embodiments, the requesting application is associated with the M2M network node.

In some embodiments, the processor may be further adapted to cause the communication interface to forward the response to the application.

In some embodiments, the processor may be further adapted to determine that a second response, generally comprising an indication (e.g. confirmation) of the reception of the CDR by the infrastructure node, is received at the communication interface.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a block diagram of an exemplary network architecture in which the present invention can be deployed.

FIG. 2 is a message flow and signaling diagram for managing charging information according to a first exemplary embodiment.

FIG. 3 is a message flow and signaling diagram for managing charging information according to a second exemplary embodiment.

FIG. 4 is a message flow and signaling diagram for managing charging information according to a third exemplary embodiment.

FIG. 5 is a message flow and signaling diagram for managing charging information according to a fourth exemplary embodiment.

FIG. 6 is a method flowchart according to the embodiments of FIGS. 2 and 3.

FIG. 7 is a method flowchart according to the embodiments of FIGS. 4 and 5.

FIG. 8 is a block diagram of an exemplary embodiment of a communication node.

FIG. 9 is a block diagram of another exemplary embodiment of a communication node.

FIG. 10 is a block diagram of another exemplary embodiment of a communication node.

### DETAILED DESCRIPTION

The present invention is generally directed to methods and systems for managing charging information in a machine-to-machine (M2M) network (also referred to as machine-type-communication (MTC) network).

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

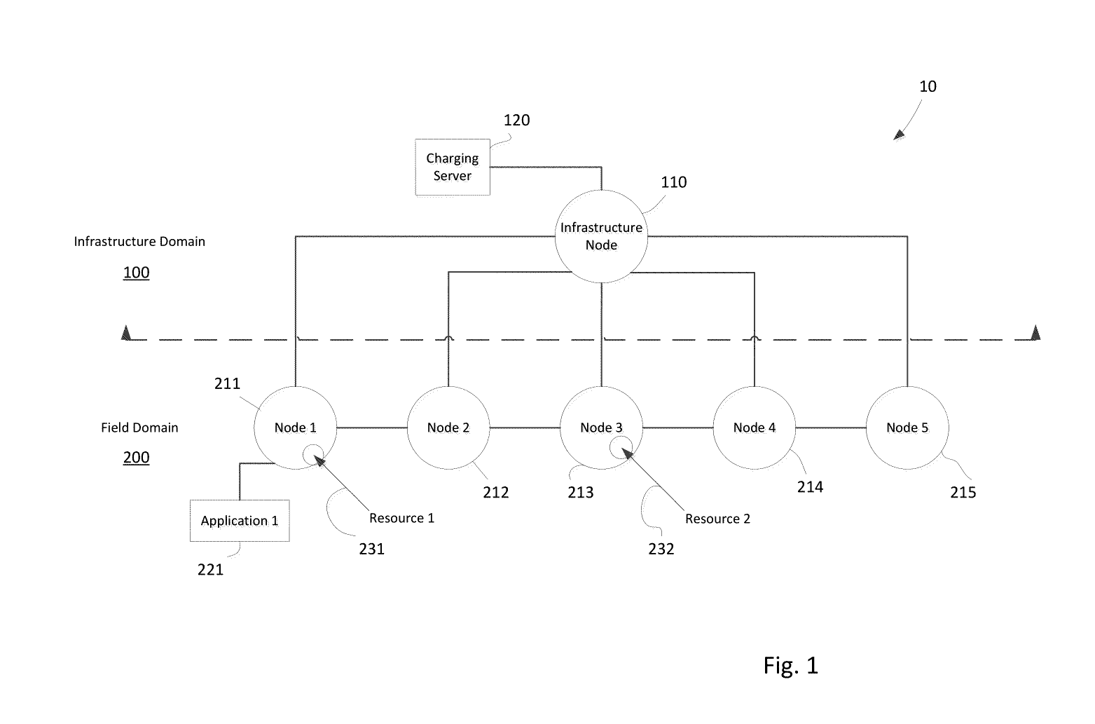

According to exemplary embodiments of the present invention, proper management of the charging information can be performed without having a central infrastructure node processing each and every request occurring between various network nodes in a M2M network. In that sense, an exemplary M2M network in which embodiments of the present invention can be deployed is depicted in FIG. 1. In present embodiments, the M2M network 10 is generally partitioned into an infrastructure domain 100 and a field domain 200.

In present embodiments, the infrastructure domain 100 comprises an infrastructure node 110 and a charging server 120 (or charging node) directly or indirectly connected to the infrastructure node 110. Though not shown in FIG. 1, the infrastructure domain 100 can also comprise a carrier network to which the infrastructure node 110 would be connected. The carrier network is generally adapted to allow the M2M network 10 to transmit and receive data from network entities located outside the M2M network 10. For its part, the field domain 200 generally comprises several (e.g. at least two) network nodes 211-215, sometimes referred to as middle nodes, to which applications can be associated (e.g. registered with). In present embodiments, network nodes 211-215 also can host resources (e.g. databases, applications, etc.). Network nodes 211-215 can register with each other and/or with the infrastructure node 110 to provide services to applications. In FIG. 1, five network nodes 211-215 are illustrated, Node 1 (211), Node 2 (212), Node 3 (213), Node 4 (214) and Node 5 (215), one application is illustrated, Application 1 (221), and two resources are illustrated, Resource 1 (231) and Resource 2 (232). Also, in FIG. 1, Application 1 (221) is shown associated with Node 1 (211), Resource 1 (231) is shown hosted on Node 1 (211), and Resource 2 (232) is shown hosted on Node 3 (213). Understandably, the number of network nodes, applications and resources can vary.

The applications and resources present in the M2M network 10 can vary. For instance, if the M2M network 10 is deployed by an electric utility company, then an application could be responsible for collecting electric usage data from a plurality of smart meters, and the resources could be the metering device located in each smart meter.

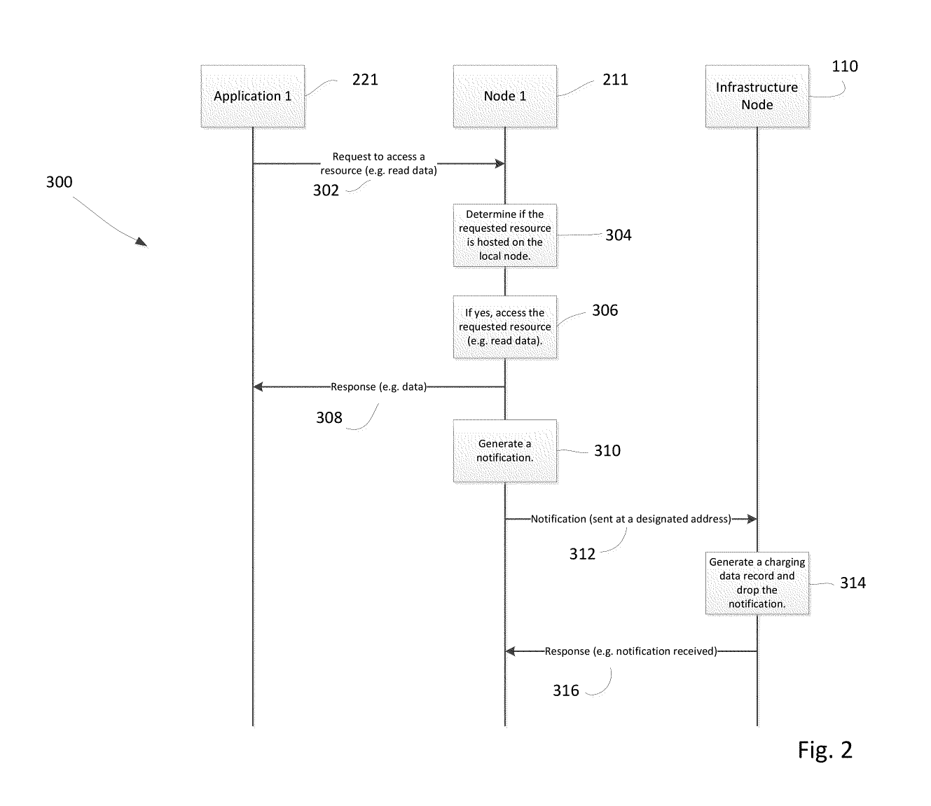

Referring now to FIG. 2, an exemplary message flow and signaling diagram 300 according to a first embodiment will now be described. According to the first embodiment, when an application, e.g. Application 1 (221), needs to access a resource, e.g. Resource 1 (231), it first sends a request to access the resource (step 302) to the network node, e.g. Node 1 (211) to which Application 1 (221) is associated. Notably, Application 1 (221) is typically already registered with Node 1 (211) to be able to initiate any request. Upon receiving the request, Node 1 (211) typically determines (step 304) whether Resource 1 (231) is hosted on it (e.g. a local resource) or not (e.g. a remote resource). In the present example, Resource 1 (231) is hosted on Node 1 (211) as shown in FIG. 1. Consequently, Node 1 (211) accesses the Resource 1 directly (step 306).

After having processed the request and accessed the resource, Node 1 (211) optionally sends back a response (step 308) to Application 1 (221). Depending on the type of request sent by Application 1 (221) (e.g. read, write, delete, or update data, etc.), a response could not always be necessary. On the one hand, if, for instance, the requesting application only sends non-critical metering data to the resource, a response to such a request could be unnecessary (e.g. to reduce data traffic in the network). On the other hand, if, for instance, the requesting application requests to receive data from the resource, then a response would be necessary as it would either include the requested data or an indication that the requested data is not available. Hence, the presence or absence of response would depend on the request sent by Application 1 (221). Similarly, the content of the optional response will generally depend on the type of request sent by Application 1 (221).

Node 1 (211) then generates a notification (step 310). The notification may generally comprise at least some of the information contained in the initial request and/or at least some of the information contained in the response. For instance, the notification could include an identification of the requesting application (i.e. Application 1 (221)), an identification of the requested resource (i.e. Resource 1 (231)), and an identification of the type of request (e.g. read data from resource). The notification could comprise different and/or additional information. In some embodiments, the notification could substantially be a copy of the initial request and/or of the response (e.g. copy of the initial request and/or of the response with an additional or modified header). After having generated the notification (step 310), Node 1 (211) transmits this notification (step 312) to the infrastructure node 110. In the present embodiment, the notification is transmitted to a designated address on the infrastructure node 110 which is dedicated to receive such notifications from network nodes.

Upon receiving the notification, the infrastructure node 110 retrieves the necessary information from the notification and generates a charging data record (CDR) for the initial request and drops the notification (step 314). Depending on the exact architecture of the network 10, the infrastructure node 110 could process the CDR itself if it comprises, for instance, a charging function. Alternatively, the infrastructure node 110 could forward the generated CDR to a charging server 120, connected to the infrastructure node 110, for further processing.

In the present embodiment, the infrastructure node 110 further sends a response (step 316) to Node 1 (211) to confirm the safe reception of the notification. This response allows Node 1 (211) to handle transmission errors (e.g. through retransmission) should no response be received. In other embodiments, the transmission of the response by the infrastructure node 110 could be omitted.

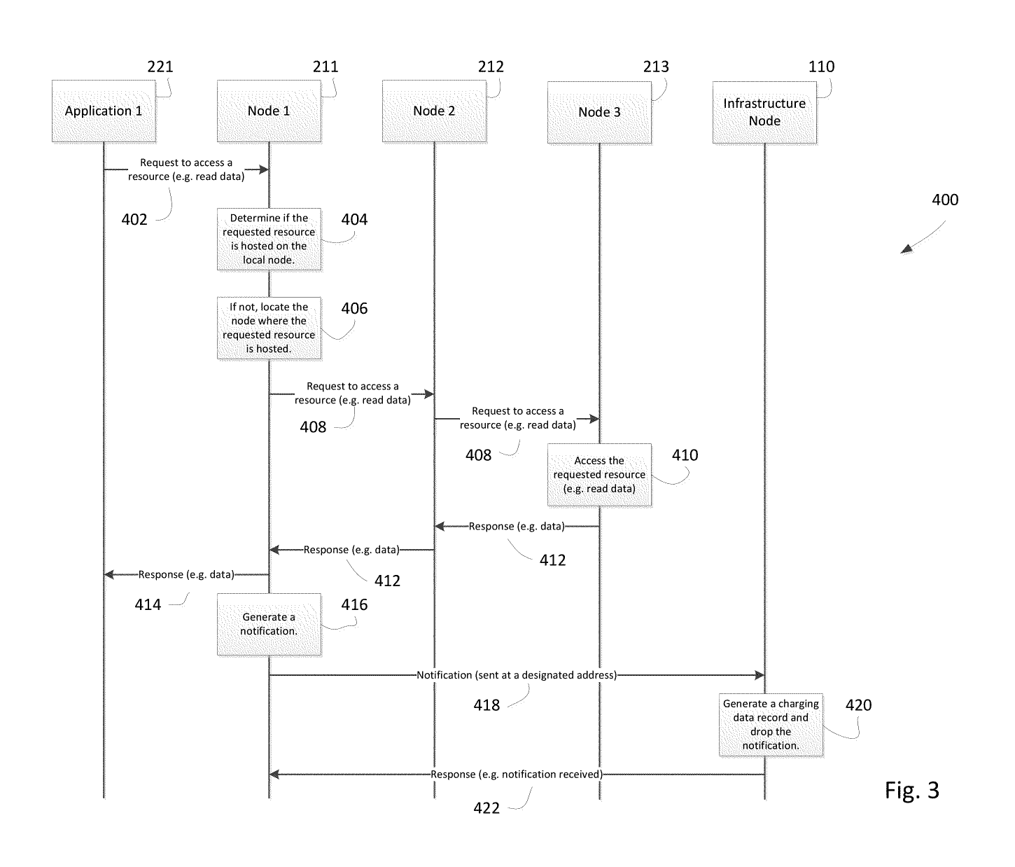

Referring now to FIG. 3, an exemplary message flow and signaling diagram 400 according to a second embodiment will now be described. According to the second embodiment, when Application 1 (221) needs to access Resource 2 (232), it first sends a request to access the resource (step 402) to Node 1 (211) to which Application 1 (221) is associated. Upon receiving the request, Node 1 (211) typically determines (step 404) whether Resource 2 (232) is hosted on it (e.g. a local resource) or not (e.g. a remote resource). In the present example, Node 1 (211) determines that Resource 2 (232) is not hosted on it. So, Node 1 (211) locates where Resource 2 (232) is hosted (step 406). In the present case, Node 1 (211) determines that Resource 2 (232) is hosted on Node 3 (213) as shown in FIG. 1. Consequently, Node 1 (211) forwards the request (step 408) toward Node 3 (213). If Node 3 (213) is directly connected to the Node 1 (211), Node 1 (211) forwards the request directly to Node 3 (213). Otherwise, Node 1 (211) forwards the request to the next node in the path between Node 1 (211) and Node 3 (213). For instance, in the present example, Node 1 (211) forwards the request to Node 2 (212) which further forwards the request to Node 3 (213). Upon receiving the request, Node 3 (213) processes it and accesses Resource 2 (232) as requested (step 410). In the embodiment of FIG. 3, it is assumed that Node 1 (211) and Node 2 (212), and Node 2 (212) and Node 3 (213) are registered with each other so they can send messages to each other.

Depending on the type of request sent by Application 1 (221) (e.g. read, write, delete, or update data, etc.), Node 3 (213) sends back an appropriate response (step 412) toward Node 2 (212). Upon receiving the response from Resource 2 (232), Node 2 (212) forwards it toward Node 1 (211). Again, since in the present example, Node 3 (213) is connected to Node 1 (211) via Node 2 (212), Node 3 (213) forwards the response to Node 2 (212) which further forwards it to Node 1 (211). Depending on the type of request, Node 1 (211) may or may not forward it to Application 1 (221). In the present embodiment, Node 1 (211) forwards the response (step 414) to Application 1 (221). Understandably, for charging purposes, Node 1 (211) must generally be aware whether the request it forwarded was successful. In that sense, the response Node 1 (211) receives from Node 3 (213) allows Node 1 (211) to confirm the success or failure of the forwarded request.

Then, Node 1 (211) proceeds as in the first embodiment and generates a notification (step 416) which generally comprises at least some of the information contained in the initial request and/or at least some of the information contained in the response. After having generated the notification, Node 1 (211) transmits the notification (step 418) to the infrastructure node 110. In the present embodiment, the notification is transmitted to a designated address on the infrastructure node 110 which is dedicated to receive such notifications from network nodes.

Upon receiving the notification, the infrastructure node 110 retrieves the necessary information from the notification and generates a charging data record (CDR) for the initial request and drops the notification (step 420). Depending on the exact architecture of the network 10, the infrastructure node 110 could process the CDR itself if it comprises, for instance, a charging function. Alternatively, the infrastructure node 110 could forward the generated CDR to a charging server 112, connected to the infrastructure node 110, for further processing.

In the present embodiment, the infrastructure node 110 further sends a response (step 422) to Node 1 (211) to confirm the safe reception of the notification. This response allows Node 1 (211) to handle transmission errors (e.g. through retransmission) should no response be received. In other embodiments, the transmission of the response by the infrastructure node 110 could be omitted.

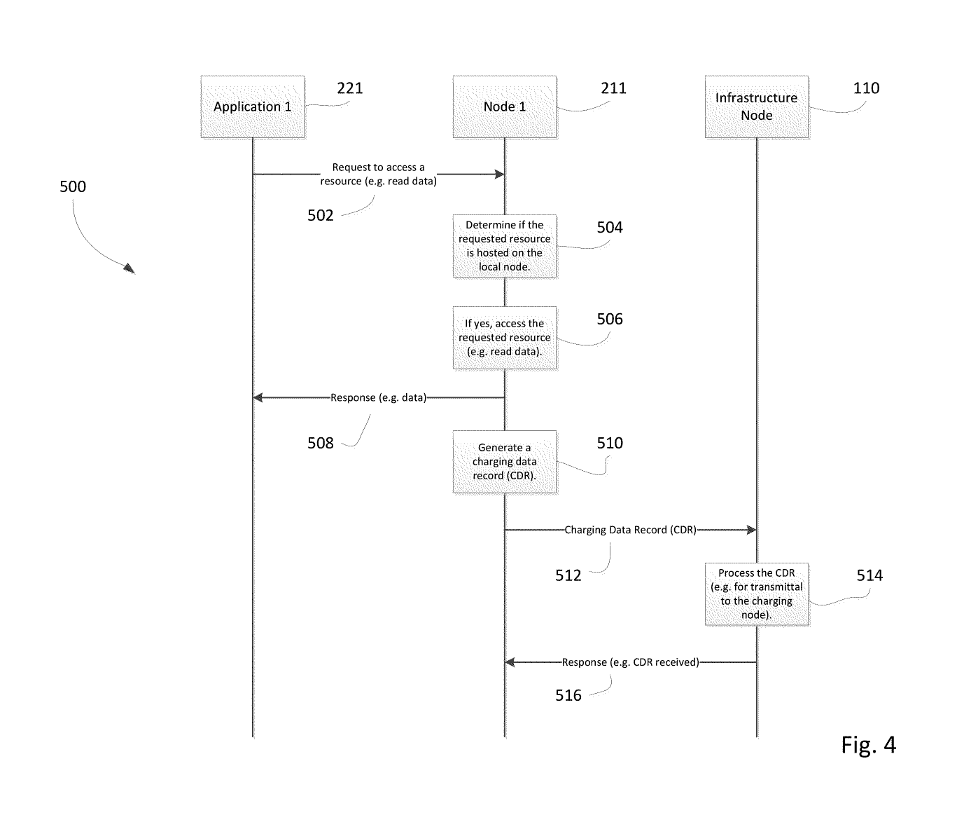

Referring now to FIG. 4, an exemplary message flow and signaling diagram 500 according to a third embodiment will now be described. According to the third embodiment, when Application 1 (221) needs to access Resource 1 (231), it first sends a request (step 502) to access the resource to Node 1 (211) to which Application 1 (221) is associated. Upon receiving the request, Node 1 (211) typically determines (step 504) whether Resource 1 (231) is hosted on it (e.g. a local resource) or not (e.g. a remote resource). In the present example, Resource 1 (231) is hosted on Node 1 (211). Consequently, Node 1 (211) accesses Resource 1 (231) directly (step 506).

As it has been described above, depending on the type of request sent by Application 1 (221) (e.g. read, write, delete, or update data, etc.), Node 1 (211) may or may not send back a response (step 508) to Application 1 (221). For instance, if the request involved the reading of data from Resource 1 (231), a response would generally be necessary as the response would include either the requested data or an indication that the requested data is not available.

Node 1 (211) then generates a charging data record (CDR) for the initial request (step 510). The CDR would generally be based on the type of request sent by Application 1 (221) and on charging rules stored on Node 1 (211). After having generated the CDR, Node 1 (211) then transmits it to the infrastructure node 110 (step 512). In the present embodiment, the CDR could be sent normally to the infrastructure node 110. In other embodiments, the CDR could be sent to a designated address on the infrastructure node 110 where all the CDRs would be sent.

Depending on the exact architecture of the network 10, upon receiving the CDR from Node 1 (211), the infrastructure node 110 could process the CDR itself, if it comprises, for instance, a charging function, or forward it to a charging server 112, connected to the infrastructure node 110, for further processing.

In the present embodiment, the infrastructure node 110 further sends a response (step 516) to Node 1 (211) to confirm the safe reception of the CDR. This response allows Node 1 (211) to handle transmission errors (e.g. through retransmission) should no response be received. In other embodiments, the infrastructure node 110 could omit to transmit a response.

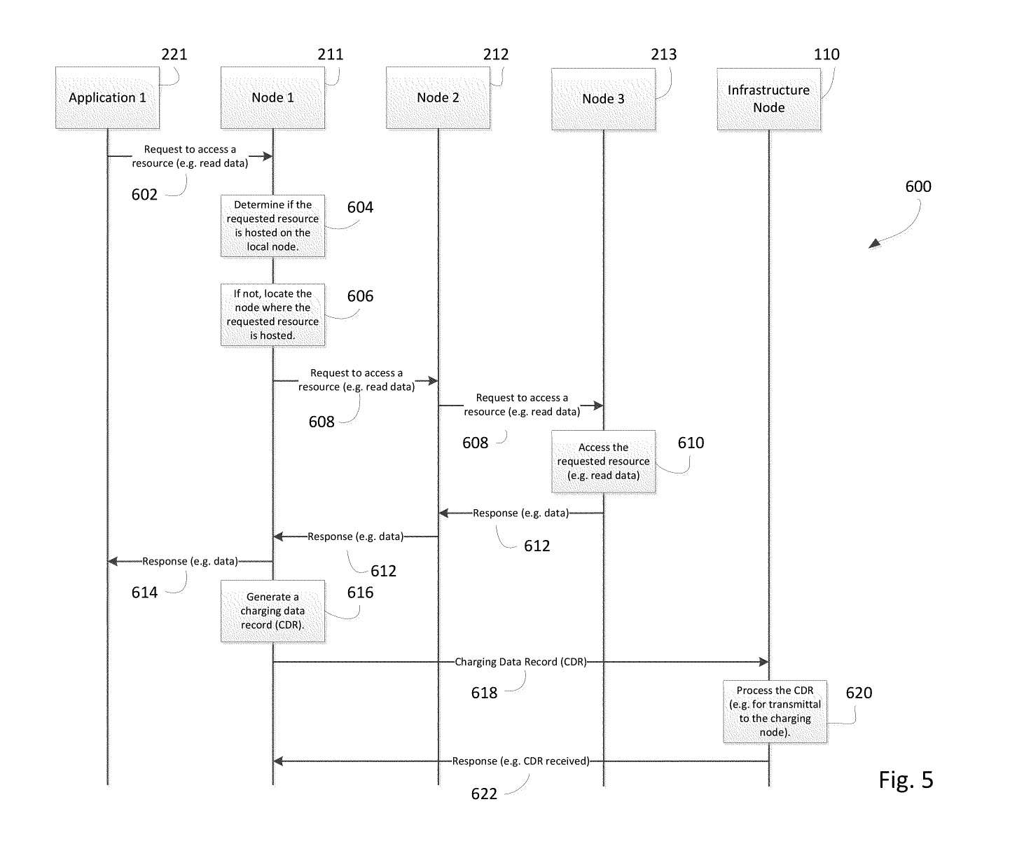

Referring now to FIG. 5, an exemplary message flow and signaling diagram 600 according to a fourth embodiment will now be described. According to the fourth embodiment, when Application 1 (221) needs to access Resource 2 (232), it first sends a request to access the resource (step 602) to Node 1 (211) to which Application 1 (221) is associated. Upon receiving the request, Node 1 (211) typically determines (step 604) whether Resource 2 (232) is hosted on it (e.g. a local resource) or not (e.g. a remote resource). In the present example, Node 1 (211) determines (step 606) that Resource 2 (232) is hosted on Node 3 (213) as shown in FIG. 1. So, Node 1 (211) forwards the request (step 608) toward Node 3 (213). As in the second embodiment (see FIG. 3), in the present example, since Node 1 (211) is not directly connected to (or registered with) Node 3 (213), Node 1 (211) forwards the request to Node 2 (212) which further forwards the request to Node 3 (213) since Node 1 (211) is connected to Node 3 (213) via Node 2 (212). Upon receiving the request, Node 2 (212) forwards it to Node 3 (213) (step 608).

Upon receiving the request, Node 3 (213) processes it and accesses Resource 2 (232) as requested (step 610). Depending on the type of request sent by Application 1 (221) (e.g. read, write, delete, or update data, etc.), Node 3 (213) sends back an appropriate response (step 612) toward Node 2 (212) which forwards (step 612) it towards Node 1 (211). Upon receiving the response, Node 1 (211) may or may not forward it (step 614) to Application 1 (221).

Node 1 (211) then proceeds as in the third embodiment (see FIG. 4) and generates a charging data record (CDR) for the initial request (step 616). The CDR would generally be based on the type of request and on charging rules stored on Node 1 (211). After having generated the CDR, Node 1 (211) transmits it to the infrastructure node 110 (step 618). In the present embodiment, the CDR could be sent normally to the infrastructure node 110. In other embodiments, the CDR could be sent to a designated address on the infrastructure node 110 where all the CDRs would be sent.

Upon receiving the CDR from Node 1 (211), the infrastructure node 110 could process the CDR itself, if it comprises, for instance, a charging function, or forward it to a charging server 112, connected to the infrastructure node 110, for further processing (step 620).

In the present embodiment, the infrastructure node 110 further sends a response (step 622) to Node 1 (211) to confirm the safe reception of the CDR. This response allows Node 1 (211) to handle transmission errors (e.g. through retransmission) should no response be received. In other embodiments, the infrastructure node 110 could omit to transmit a response.

Understandably, by only sending the required information to the infrastructure node 110 (e.g. via the transmission of a notification, via the transmission of a CDR, etc.) while not having the infrastructure node 110 directly processing each and every request, the processing burden on the infrastructure node 110 can be reduced while still allowing the proper monitoring and managing of the charging information.

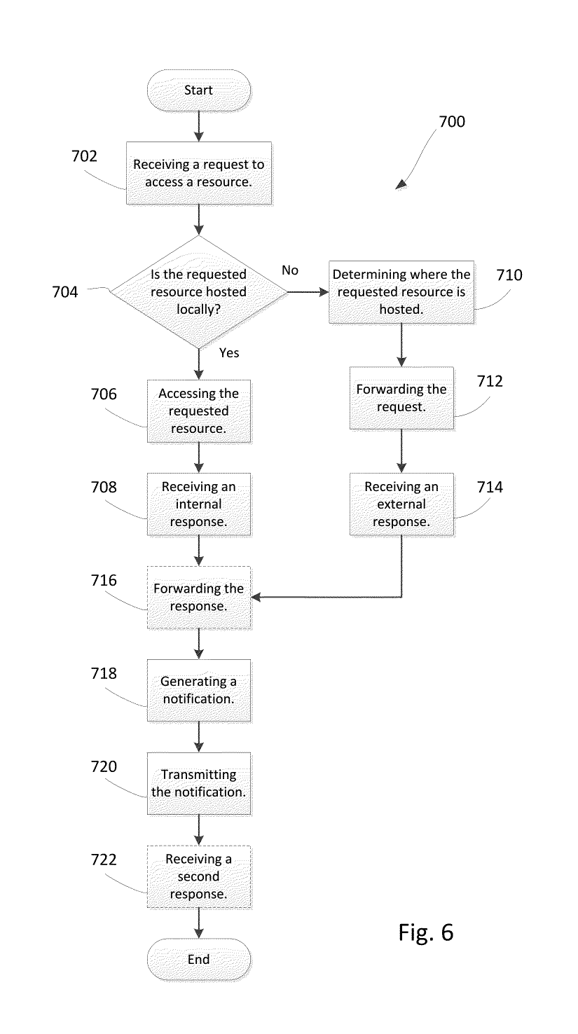

An embodiment of the present invention as implemented by a network node (e.g. Node 1 (211) in FIG. 1) can be further illustrated by the flow chart 700 depicted in FIG. 6. In the embodiment of FIG. 6, the network node receives, at 702, a request from an application (e.g. Application 1 (221) in FIG. 1) to access a resource (e.g. Resource 1 (231) in FIG. 1). The network node then determines, at 704, whether the requested resource is hosted locally or not. If the network node determines that the requested resource is hosted locally, the network node directly accesses the requested resource, at 706, as requested (e.g. read, write, delete, or update data, etc.). Upon having accessed the locally hosted resource, the network node would receive an internal response (i.e. a response received from within the network node itself (e.g. the requested data, an acknowledgement, etc.)) at 708. Otherwise, if the network node determines that the requested resource is not hosted locally, i.e. it is hosted remotely in another network node, the network node determines, at 710, where (e.g. in which node) the requested resource is hosted. Once the network node locates where the requested resource is hosted, the network node forwards the request, at 712, toward the node where the requested resource is hosted. The network node then receives an external response (i.e. a response receive from another network node), at 714, regarding the forwarded request. The nature of the response will generally depend on the nature of the request. If, for instance, the application requested data from the resource, the response will contain either the requested data or an indication of the unavailability of the data. At 716, the network node optionally forwards the received response to the application. The network node then generates a notification, at 718, which would generally comprise at least some of the information contained in the initial request received at 702 and/or at least some of the information contained in the response. For instance, the notification could include an identification of the requesting application, an identification of the requested resource, and an identification of the type of request. The notification could also comprise different and/or additional information (e.g. a special header, charging-related information, etc.). Then, at 720, the network node transmits the notification to the infrastructure node 110. Optionally, the network node may further receive a response from the infrastructure node 110, at 722, after the transmission of the notification. The second response could confirm, for instance, the reception of the notification by the infrastructure node 110.

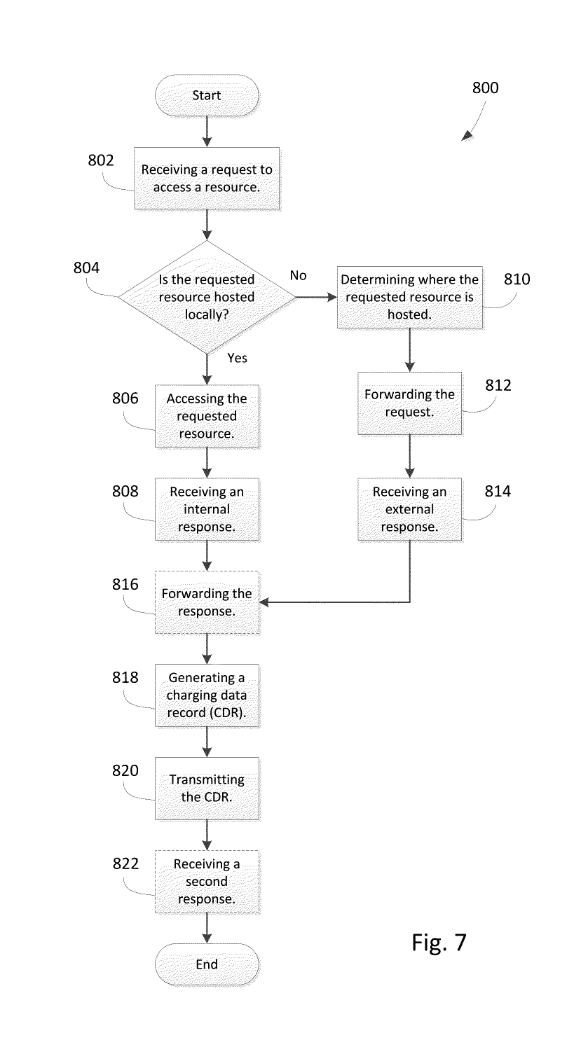

Another embodiment of the present invention as implemented by a network node (e.g. Node 1 (211) in FIG. 1) can be further illustrated by the flow chart 800 depicted in FIG. 7. In the embodiment of FIG. 7, the network node receives, at 802, a request from an application (e.g. Application 1 (221) in FIG. 1) to access a resource (e.g. Resource 1 (231) in FIG. 1). The network node then determines, at 804, whether the requested resource is hosted locally or not. If the network node determines that the requested resource is hosted locally, the network node directly accesses the requested resource, at 806, as requested (e.g. read, write, delete, or update data, etc.). Upon having accessed the locally hosted resource, the network node would receive an internal response (i.e. a response received from within the network node itself (e.g. the requested data, an acknowledgement, etc.)) at 808. Otherwise, if the network node determines that the requested resource is not hosted locally, i.e. it is hosted remotely in another network node, the network node determines, at 810, where (e.g. in which node) the requested resource is hosted. Once the network node locates where the requested resource is hosted, the network node forwards the request, at 812, toward the node where the requested resource is hosted. The network node then receives an external response (i.e. a response receive from another network node), at 814, regarding the forwarded request. The nature of the response will generally depend on the nature of the request. If, for instance, the application requested data from the resource, the response will contain either the requested data or an indication of the unavailability of the data. At 816, the network node optionally forwards the received response to the application. The network node then generates a charging data record (CDR), at 818, which would generally comprise at least some information contained in the initial request received at 802 and/or at least some information contained in the response. For instance, the CDR could include an identification of the requesting application, an identification of the requested resource, an identification of the type of request, and other charging information (e.g. charging rules). The CDR could also comprise additional information. Then, at 820, the network node transmits the CDR to the infrastructure node 110. Optionally, the network node may further receive a response from the infrastructure node 110, at 822, after the transmission of the CDR. The second response could confirm, for instance, the reception of the CDR by the infrastructure node 110.

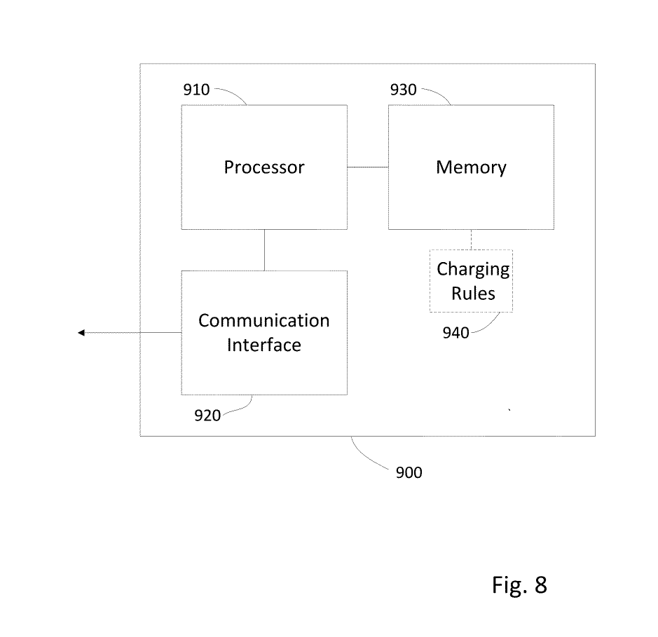

Referring now to FIG. 8, an exemplary embodiment of a network node 900 is illustrated. Without limitations, network node 900 illustrated in FIG. 8 could be used to implement the embodiments shown in FIGS. 2 to 7.

Network node 900 generally comprises a processor 910, a communication interface 920 operatively connected to the processor 910, and a memory 930 also operatively connected to the processor 910. The communication interface 920 provides access to the network 10. The memory 930 stores, among other information, instructions which, upon being executed by the processor 910, allow the network node 900 to carry out the methods described (e.g. the methods described with reference to the flow charts of FIGS. 6 and 7).

Understandably, when instructions stored in the memory 930 of the network node 900 are adapted to carry out methods in which the network node generates 900 charging data records for transmission to the infrastructure node 110, the memory 930 would further comprise a charging rules database 940. The charging rules database 940 would generally comprise all the necessary charging rules to allow the network node 900 to generate the proper charging data records (CDRs).

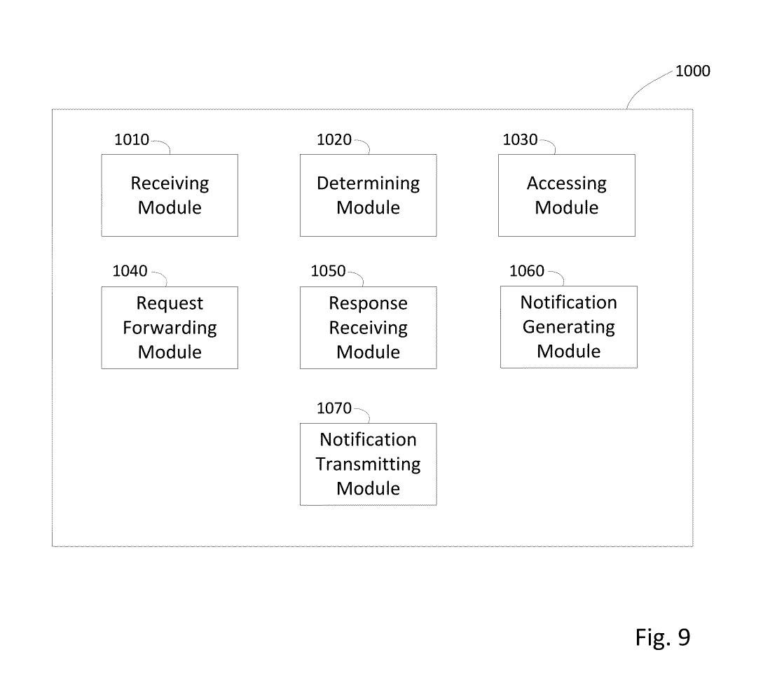

Referring now to FIG. 9, another exemplary embodiment of a network node 1000 is illustrated. Without limitations, network node 1000 illustrated in FIG. 9 could be used to implement the embodiments shown in FIG. 6.

Network node 1000 generally comprises a receiving module 1010 for receiving, from an application (e.g. Application 1 (221) in FIG. 1), a request to access a resource (e.g. Resource 1 (231) in FIG. 1), a determining module 1020 for determining on which network node the requested resource is hosted, an accessing module 1030 for accessing the requested resource when the requested resource is determined to be hosted on the network node, a request forwarding module 1040 for forwarding the request to another network node when the requested resource is determined to be hosted on the another network node, a response receiving module 1050 for receiving a response, the response comprising an indication of the access to the resource, a notification generating module 1060 for generating a notification based on the request or on the response; and a notification transmitting module 1070 for transmitting the notification to an infrastructure node.

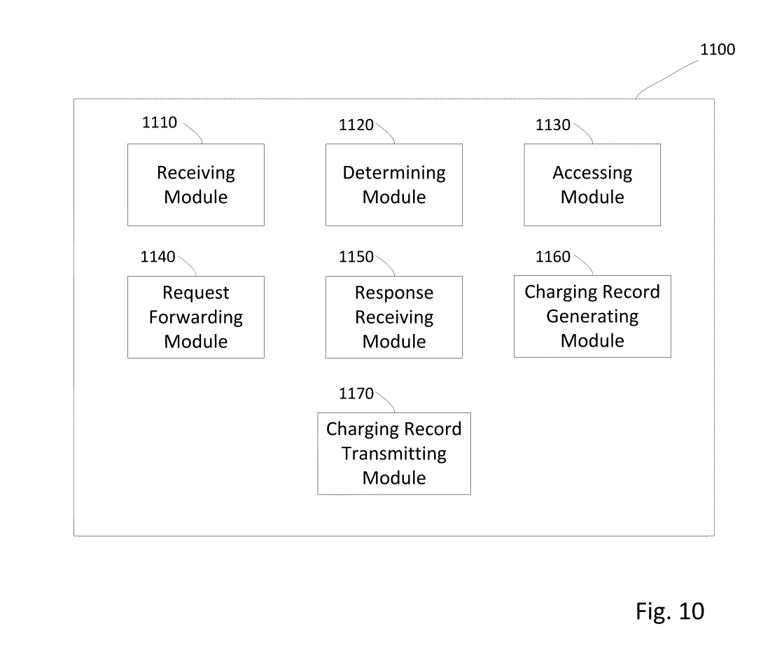

Referring now to FIG. 10, another exemplary embodiment of a network node 1100 is illustrated. Without limitations, network node 1100 illustrated in FIG. 10 could be used to implement the embodiments shown in FIG. 7.

Network node 1100 generally comprises a receiving module 1110 for receiving, from an application (e.g. Application 1 (221) in FIG. 1), a request to access a resource (e.g. Resource 1 (231) in FIG. 1), a determining module 1120 for determining on which network node the requested resource is hosted, an accessing module 1130 for accessing the requested resource when the requested resource is determined to be hosted on the network node, a request forwarding module 1140 for forwarding the request to another network node when the requested resource is determined to be hosted on another network node, a response receiving module 1050 for receiving a response, the response comprising an indication of the access to the resource, a charging record generating module 1160 for generating a charging record based on the request or on the response, and a charging record transmitting module 1170 for transmitting the charging record to an infrastructure node.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

1. A method for managing charging information in a machine-to-machine (M2M) network, the method comprising:
at a first M2M network node, receiving, from an application, a request to access a resource;
accessing the requested resource, if the requested resource is determined to be hosted on the first M2M network node, or forwarding the request to a second M2M network node, if the requested resource it is determined to be hosted on the second M2M network node, in accordance with determining in which M2M network node the requested resource is hosted;
receiving a response comprising an indication of the access to the resource;
responsive to receiving the response, generating a notification comprising at least some information from the request or from the response;
transmitting the notification to a M2M infrastructure node.

2. A method as claimed in claim 1, wherein the notification is transmitted to a predetermined address on the M2M infrastructure node.

3. A method as claimed in claim 1, wherein the notification comprises at least some information from the request and from the response.

4. A method as claimed in claim 1, wherein the notification comprises charging-related information.

5. A method as claimed in claim 1, further comprising forwarding the response to the application.

6. A method as claimed in claim 1, further comprising receiving a second response from the M2M infrastructure node, the second response comprising an indication of the reception of the notification.

7. A method as claimed in claim 1, wherein the M2M infrastructure node is located in an infrastructure domain and the first M2M network node is located in a field domain.

8. A machine-to-machine (M2M) network node comprising:
a communication interface;
a memory for storing instructions; and
a processor, the processor being operatively connected to the communication interface and to the memory, which upon executing instructions stored in the memory, is adapted to:
determine that a request for access to a resource is received at the communication interface from an application;
determine in which M2M network node the requested resource is hosted;
access the requested resource, if the requested resource is determined to be hosted on the M2M network node, or cause the communication interface to forward the request to another M2M network node, if the requested resource is determined to be hosted on the another M2M network node;
determine that a response comprising an indication of the access to the resource is received;
generate a notification comprising at least some information from the request or from the response;
cause the communication interface to transmit the notification to a M2M infrastructure node.

9. A M2M network node as claimed in claim 8, wherein the processor is adapted to cause the communication interface to transmit the notification to a predetermined address on the M2M infrastructure node.

10. A M2M network node as claimed in claim 8, wherein the notification comprises at least some information from the request and from the response.

11. A M2M network node as claimed in claim 8, wherein the notification comprises charging-related information.

12. A M2M network node as claimed in claim 8, wherein the processor is further adapted to cause the communication interface to forward the response to the application.

13. A M2M network node as claimed in claim 8, wherein the processor is further adapted to determine that a second response comprising an indication of the reception of the notification is received at the communication interface.

14. A M2M network node as claimed in claim 8, wherein the M2M infrastructure node is located in an infrastructure domain and the M2M network node is located in a field domain.

15. A method for managing charging information in a machine-to-machine (M2M) network, the method comprising:
at a first M2M network node, receiving, from an application, a request to access a resource;
accessing the requested resource, if the requested resource is determined to be hosted on the first M2M network node, or forwarding the request to a second M2M network node, if the requested resource it is determined to be hosted on the second M2M network node, in accordance with determining in which M2M network node the requested resource is hosted;
receiving a response comprising an indication of the access to the resource;
responsive to receiving the response, generating a charging record comprising an indication of the access to the resource by the application;
transmitting the charging record to a M2M infrastructure node.

16. A method as claimed in claim 15, further comprising forwarding the response to the application.

17. A method as claimed in claim 15, further comprising receiving a second response from the M2M infrastructure node, the second response comprising an indication of the reception of the charging record.

18. A method as claimed in claim 15, wherein the M2M infrastructure node is located in an infrastructure domain and the first M2M network node is located in a field domain.

19. A machine-to-machine (M2M) network node comprising:
a communication interface;
a memory for storing instructions; and
a processor, the processor being operatively connected to the communication interface and to the memory, which upon executing instructions stored in the memory, is adapted to:
determine that a request for access to a resource is received at the communication interface from an application;
determine in which M2M network node the requested resource is hosted;
access the requested resource, if the requested resource is determined to be hosted on the M2M network node, or cause the communication interface to forward the request to another M2M network node, if the requested resource is determined to be hosted on the another M2M network node;
determine that a response comprising an indication of the access to the resource is received;
generate a charging record comprising an indication of the access to the resource by the application;
cause the communication interface to transmit the charging record to a M2M infrastructure node.

20. A M2M network node as claimed in claim 19, wherein the processor is further adapted to cause the communication interface to forward the response to the application.

21. A M2M network node as claimed in claim 19, wherein the processor is further adapted to determine that a second response comprising an indication of the reception of the charging record is received at the communication interface.

22. A M2M network node as claimed in claim 19, wherein the M2M infrastructure node is located in an infrastructure domain and the M2M network node is located in a field domain.

23. (canceled)

24. (canceled)
